(19) United States
(12) Patent Application Publication
(10) Pub. No.: US 2019/0147814 A1
(43) Pub. Date: May 16, 2019

(54) DISPLAY DEVICE AND OPERATION METHOD THEREOF

(71) Applicant: Himax Display, Inc., Tainan City (TW)

(72) Inventors: Yuet-Wing Li, Tainan City (TW); Wen-Hsu Chen, Tainan City (TW)

(73) Assignee: Himax Display, Inc., Tainan City (TW)

(21) Appl. No.: 15/970,890

(22) Filed: May 4, 2018

Related U.S. Application Data
(60) Provisional application No. 62/585,554, filed on Nov. 14, 2017.

(51) Int. Cl. G09G 3/36

(52) U.S. Cl. CPC G09G 3/3648; G09G 2320/064; G09G 2360/18; G09G 2300/0842

(57) ABSTRACT

A display device and an operation method thereof are provided. The display device includes a display panel and a light source circuit. The display panel includes a color filter layer and a plurality of pixel circuits. The pixel circuits respectively include a first preload switch, a second preload switch, a first storage capacitor, a second storage capacitor, a first driving switch, a second driving switch, and a pixel element. The light source circuit includes a dimming circuit and at least one light-emitting element. The dimming circuit drives the light-emitting element to generate a light according to a duty ratio related to a response time of the pixel elements of the pixel circuits, wherein the light passes through the color filter layer and the pixel elements of the pixel circuits to display an image.

### CROSS-REFERENCE TO RELATED APPLICATION

This application claims the priority benefit of U.S. provisional application Ser. No. 62/585,554, filed on Nov. 14, 2017. The entirety of the above-mentioned patent application is hereby incorporated by reference herein and made a part of this specification.

### BACKGROUND OF THE INVENTION

### Field of the Invention

The disclosure relates to an electronic device, and in particular, to a display device and an operation method thereof.

### Description of Related Art

Solutions for true light field display are currently not commercially available. That is because a frame rate of all thin film transistor (TFT) displays using progressive scanning is limited.

### SUMMARY OF THE INVENTION

The embodiments of the invention provide a display device and an operation method thereof that satisfy an application requirement for a high frame rate and reduce motion blur.

An embodiment of the invention provides a display device. The display device includes a display panel and a light source circuit. The display panel includes a color filter layer and a plurality of pixel circuits. The pixel circuits respectively include a first preload switch, a second preload switch, a first storage capacitor, a second storage capacitor, a first driving switch, a second driving switch, and a pixel element. A first terminal of the first preload switch and a first terminal of the second preload switch are coupled to a data line of the display panel. A first terminal of the first storage capacitor is coupled to a second terminal of the first preload switch and a first terminal of the first driving switch. A first terminal of the second storage capacitor is coupled to a second terminal of the second preload switch and a first terminal of the second driving switch. A second terminal of the first driving switch and a second terminal of the second driving switch are coupled to the pixel element. The light source circuit includes a dimming circuit and at least one light-emitting element. The dimming circuit drives the light-emitting element to generate a light according to a duty ratio related to a response time of the pixel elements of the pixel circuits, wherein the light passes through the color filter layer and the pixel elements of the pixel circuits to display an image.

An embodiment of the invention provides a method of operating a display device. The method includes the following steps. A display panel is provided. A dimming circuit drives at least one light-emitting element to generate a light according to a duty ratio. The display panel includes a color filter layer and a plurality of pixel circuits. The pixel circuits respectively include a first preload switch, a second preload switch, a first storage capacitor, a second storage capacitor, a first driving switch, a second driving switch, and a pixel element. A first terminal of the first preload switch and a first terminal of the second preload switch are coupled to a data line of the display panel. A first terminal of the first storage capacitor is coupled to a second terminal of the first preload switch and a first terminal of the first driving switch. A first terminal of the second storage capacitor is coupled to a second terminal of the second preload switch and a first terminal of the second driving switch. A second terminal of the first driving switch and a second terminal of the second driving switch are coupled to the pixel element. The duty ratio is related to a response time of the pixel elements of the pixel circuits. The light passes through the color filter layer and the pixel elements of the pixel circuits to display an image.

Accordingly, the display device and the operation method thereof described in the embodiments of the invention use a color filter display panel having a function of analog frame buffer and can thus satisfy an application requirement for a high frame rate. Moreover, the dimming circuit described in the embodiments of the invention controls/drives the light-emitting element according to the duty ratio related to the response time of the pixel element and can thus reduce/improve motion blur.

To provide a further understanding of the aforementioned and other features and advantages of the disclosure, exemplary embodiments, together with the reference drawings, are described in detail below.

### BRIEF DESCRIPTION OF THE DRAWINGS

FIG. 1 is a circuit block schematic diagram illustrating a display device according to an embodiment of the invention.

FIG. 2 is a cross-sectional schematic diagram illustrating a display panel shown in FIG. 1 according to an embodiment of the invention.

FIG. 3 is a circuit schematic diagram illustrating a pixel circuit of the display panel shown in FIG. 1 according to an embodiment of the invention.

FIG. 4 is a flowchart illustrating a method of operating a display device according to an embodiment of the invention.

FIG. 5 is a schematic diagram illustrating a phase relationship between a duty ratio of a light source and a response time of a liquid crystal capacitor (pixel element) according to an embodiment of the invention.

### DESCRIPTION OF THE EMBODIMENTS

The term “couple or (connect)” used throughout the specification (including the claims) refers to any direct or indirect connection means. For example, if a first device is described to be coupled (or connected) to a second device in the text, it is interpreted that the first device may be directly connected to the second device, or that the first device may be indirectly connected to the second device via other devices or some connection means. Moreover, wherever possible, elements/components/steps labeled with the same reference numerals represent the same or similar parts in the drawings and embodiments. Reference may be made between the elements/components/steps labeled with the same reference numerals or described in the same terms in different embodiments for relevant descriptions.

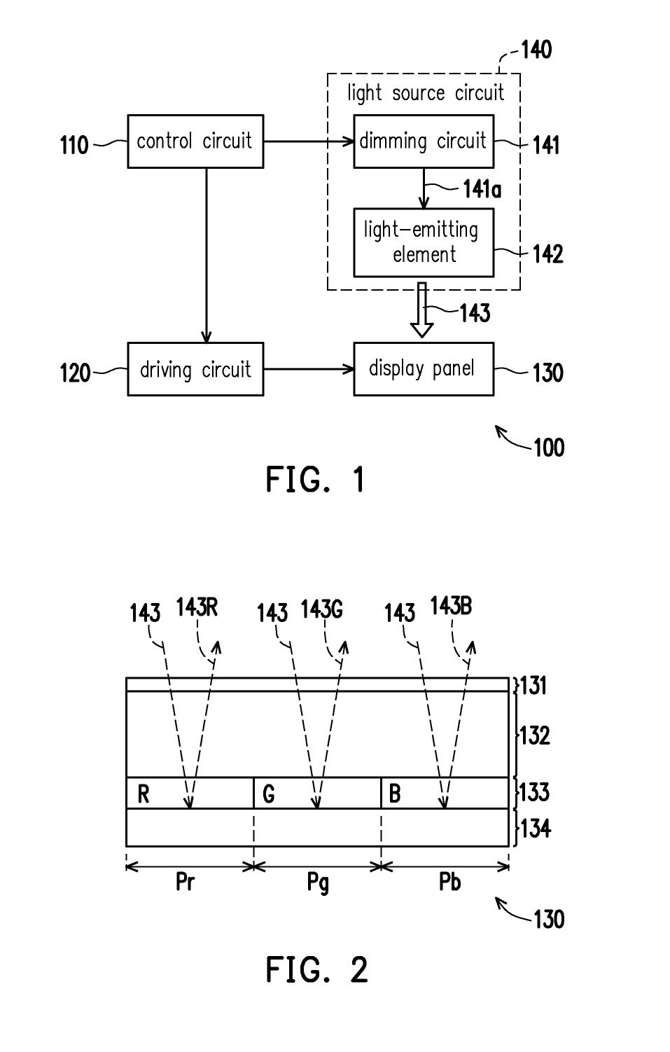

FIG. 1 is a circuit block schematic diagram illustrating a display device 100 according to an embodiment of the invention. The display device 100 includes a control circuit 110, a driving circuit 120, a display panel 130, and a light source circuit 140. The implementation of the control circuit 110 and the driving circuit 120 is not limited in the present embodiment. For example, the control circuit 110 may include a timing controller and/or other control circuits, and the driving circuit 120 may include a source driver (or referred to as a data driver), a gate driver (or referred to as a scanning driver), and/or other driving circuits. According to the design requirement, the control circuit 110 may be a conventional timing controller or another control circuit/element, and the driving circuit 120 may be a conventional driver for driving a display panel or another driving circuit/element.

The implementation of the display panel 130 is not limited in the present embodiment. For example, the display panel 130 may be a liquid crystal display (LCD) panel, a liquid crystal on silicon (LCOS) display panel, or another display panel. The display panel 130 includes a color filter layer and a plurality of pixel circuits. A light (e.g., a white light or another light) 143 passes through the color filter layer and the pixel elements (e.g., liquid crystal capacitors) of the pixel circuits to display an image.

FIG. 2 is a cross-sectional schematic diagram illustrating the display panel 130 shown in FIG. 1 according to an embodiment of the invention. In the embodiment shown in FIG. 2, the display panel 130 may be a color filter LCOS (CFLCOS). FIG. 2 shows that the display panel 130 includes a pixel Pr, a pixel Pg, and a pixel Pb, but the display panel 130 may include more pixels.

The display panel 130 includes an electrode layer 131, a liquid crystal layer 132, a color filter layer 133, and an electrode layer 134. A material of the electrode layer 131 may be any transparent (or translucent) conductive material, e.g., indium tin oxide (ITO) or another conductive material. After patterning, the electrode layer 131 is formed into an electrode (not illustrated), an element (not illustrated), and/or another component. The electrode of the electrode layer 131 may be a capacitor electrode, a common electrode, and/or another electrode. The element of the electrode layer 131 may be a switch of a pixel circuit, a storage capacitor, and/or another element. A material of the electrode layer 134 may be any non-transparent (or translucent) conductive material, e.g., metal or another conductive material. The electrode layer 134 may act as a light reflecting layer to reflect the light 143 emitted by the light source circuit 140. After patterning, the electrode layer 134 is formed into an electrode (not illustrated), an element (not illustrated), and/or another component. The electrode of the electrode layer 134 may be a capacitor electrode, a common electrode, and/or another electrode. The element of the electrode layer 134 may be a switch of a pixel circuit, a storage capacitor, and/or another element. The liquid crystal layer 132 is disposed between the electrode layer 131 and the electrode layer 134. Therefore, the electrode layer 131, the liquid crystal layer 132, and the electrode layer 134 may form different liquid crystal capacitors (pixel elements) of the plurality of pixel circuits. Layout structures of the electrode layer 131 and the electrode layer 134 may be determined according to the design requirements. For example, the layout structures of the electrode layer 131 and the electrode layer 134 may be conventional layouts or other layouts/patterns.

The color filter layer 133 is provided with one or more colors. A number of colors of the color filter layer 133 may be determined according to the design requirements. For example, in the embodiment shown in FIG. 2, the color filter layer 133 includes a red color filter layer R, a green color filter layer G, and a blue color filter layer B. The color filter layer 133 is patterned to be consistent with a geometric layout of the pixel Pr, the pixel Pg, and the pixel Pb. The light 143 passes through the color filter layer 133 to become a color light. The color light pass through the pixel elements of the pixel circuits of the display panel 130 to display an image. For example, in the embodiment shown in FIG. 2, the light 143 passes through the red color filter layer R to become a red color light 143R, the light 143 passes through the green color filter layer G to become a green color light 143G, and the light 143 passes through the blue color filter layer B to become a blue color light 143B. The color lights 143R, 143G, and 143B pass through the liquid crystal capacitors (pixel elements) of the pixel circuits to display an image.

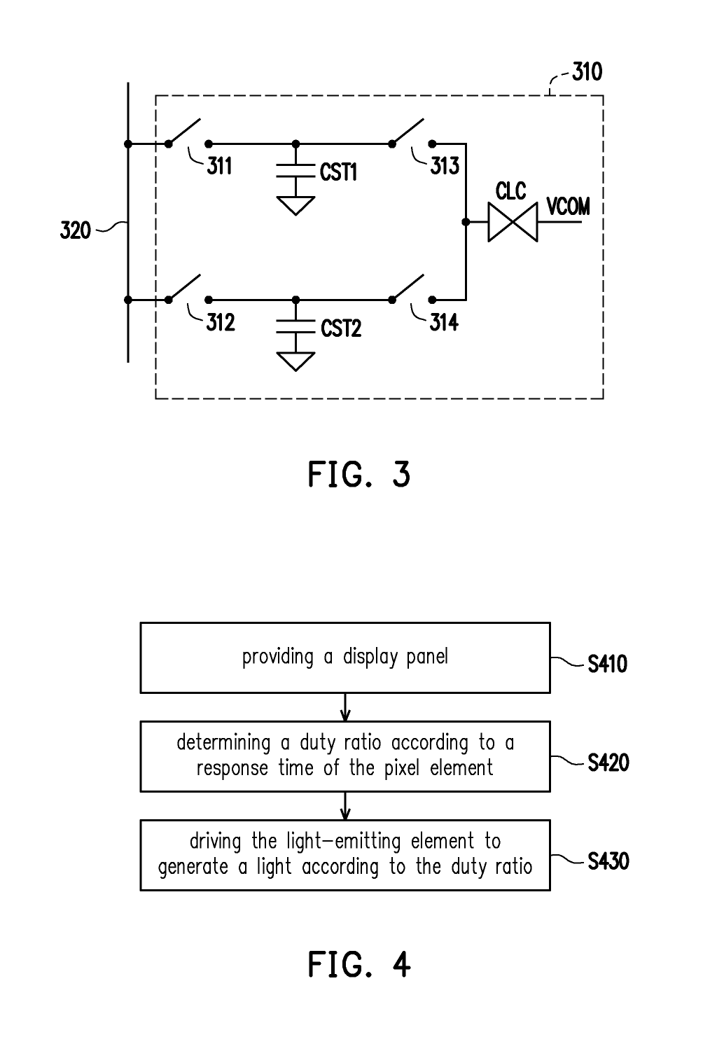

The display panel 130 shown in FIG. 1 includes the plurality of pixel circuits. FIG. 3 is a circuit schematic diagram illustrating a pixel circuit 310 of the display panel 130 shown in FIG. 1 according to an embodiment of the invention. Reference may be made to relevant descriptions of the pixel circuit 310 for descriptions of other pixel circuits (e.g., the pixel Pr, the pixel Pg, and the pixel Pb) of the display panel 130 shown in FIG. 1 and FIG. 2, which are not repeatedly described here. In the embodiment shown in FIG. 3, the pixel circuit 310 includes a first preload switch 311, a second preload switch 312, a first storage capacitor CST1, a second storage capacitor CST2, a first driving switch 313, a second driving switch 314, and a liquid crystal capacitor CLC (pixel element).

A first terminal of the first preload switch 311 and a first terminal of the second preload switch 312 are coupled to a data line 320 of the display panel. A first terminal of the first storage capacitor CST1 is coupled to a second terminal of the first preload switch 311 and a first terminal of the first driving switch 313. A first terminal of the second storage capacitor CST2 is coupled to a second terminal of the second preload switch 312 and a first terminal of the second driving switch 314. A second terminal of the first driving switch 313 and a second terminal of the second driving switch 314 are coupled to a first terminal of the liquid crystal capacitor CLC (pixel element). A second terminal of the liquid crystal capacitor CLC is coupled to a common electrode line of the display panel 130 to receive a common voltage VCOM.

During a first frame period, the first preload switch 311 and the second driving switch 314 are turned off, the first storage capacitor CST1 provides a pixel voltage of a first frame to the liquid crystal capacitor CLC (pixel element) via the first driving switch 313, and the second storage capacitor CST2 receives a pixel voltage of a second frame from the data line 320 via the second preload switch 312. During a second frame period, the second preload switch 312 and the first driving switch 313 are turned off, the second storage capacitor CST2 provides the pixel voltage of the second frame to the liquid crystal capacitor CLC (pixel element) via the second driving switch 314, and the first storage capacitor CST1 receives a pixel voltage of a third frame from the data line 320 via the first preload switch 311. Operations during other frame periods may be analogously inferred from relevant descriptions during the first frame period and the second frame period and are not repeatedly described here. Therefore, the display panel 130 has a function of analog frame buffer.

Due to the physical properties of liquid crystals, after the liquid crystal capacitor updates the pixel voltage, liquid crystals need a period of time (response time) to change the state. In conventional displays using progressive scanning, liquid crystal capacitors in different rows update the pixel voltage at different times. Since pixels in different rows update the liquid crystal state at different times, a frame rate of conventional displays is limited. The display panel 130 including the pixel circuit 310 shown in FIG. 3 may update the pixel voltage for the liquid crystal capacitors in different rows at the same time. Within a few microseconds, a full image may be updated to all liquid crystal capacitors CLC (pixel elements) of the display panel 130. All pixels will display the correct content at the same time. Therefore, the frame rate of the display panel 130 may be significantly enhanced. In some embodiments, the display panel 130 may provide a frame rate higher than 720 fps. Therefore, the display panel 130 may satisfy an application requirement for a high frame rate. For example, the display panel 130 may be applied to a multiple content field display or other high frame rate applications. The display panel 130 may display multi focal length augmented reality (AR) images (true light field).

The light source circuit 140 shown in FIG. 1 includes a dimming circuit 141 and at least one light-emitting element 142. FIG. 4 is a flowchart illustrating a method of operating a display device according to an embodiment of the invention. Refer to FIG. 1 and FIG. 4, in step S410, a display panel 130 is provided. Reference may be made to relevant descriptions of FIG. 2 to FIG. 3 for descriptions of the display panel 130, which is not repeatedly described here.

The control circuit 110 may control the dimming circuit 141 according to a luminance parameter set by a user. In step S420, the dimming circuit 141 determines a duty ratio D of a pulse-width modulation (PWM) signal 141a based on the control of the control circuit 110, wherein the duty ratio D≤1−τ/Tf, τ is a response time of the liquid crystal capacitor CLC (pixel element) of the display panel 130, and Tf is a frame time (a time period of a frame). For example, supposing that a maximum response time of all liquid crystal capacitors CLC of the display panel 130 is 1.9 ms (i.e., 0.0019 seconds), and the frame rate is 240 fps, then 0≤D≤1−0.0019*240=0.544. Based on the control of the control circuit 110, the dimming circuit 141 may select a value from a value range of 0 to 0.544 as the duty ratio D of the PWM signal 141a. Therefore, the duty ratio D is related to the response time T of the liquid crystal capacitors CLC (pixel elements) of the pixel circuits of the display panel 130.

In step S430, the dimming circuit 141 drives the light-emitting element 142 to generate a light 143 according to the duty ratio D of step S420. The implementation of the light-emitting element 142 is not limited in the present embodiment. In some embodiments, the light-emitting element 142 may include a light emitting diode (LED) and/or other light-emitting elements.

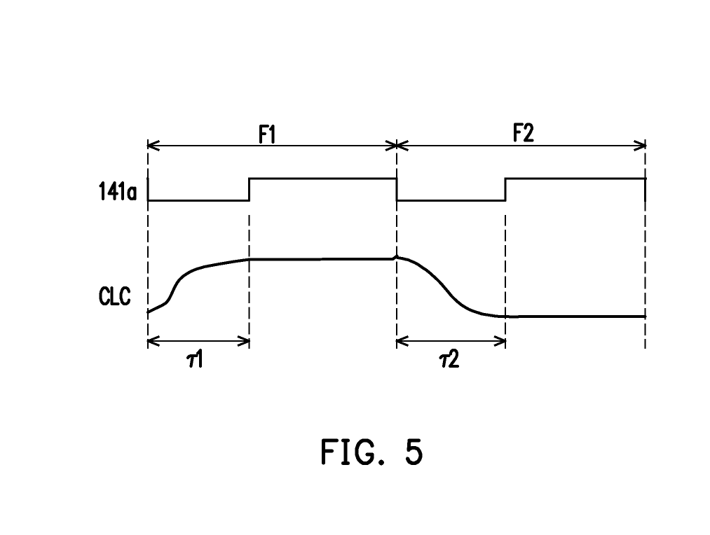

FIG. 5 is a schematic diagram illustrating a phase relationship between a duty ratio of a light source and a response time τ of the liquid crystal capacitor CLC (pixel element) according to an embodiment of the invention. The horizontal axis shown in FIG. 5 represents time. The upper part of FIG. 5 illustrates the PWM signal 141a, wherein when the PWM signal 141a is at a low level, the light-emitting element 142 does not emit light, and when the PWM signal 141a is at a high level, the light-emitting element 142 emits light 143. The lower part of FIG. 5 illustrates an optical response of the liquid crystal capacitor CLC (pixel element). During a period of a first frame F1, a positive polarity pixel voltage of the first frame F1 is simultaneously updated to the liquid crystal capacitors CLC (pixel elements) of all pixel circuits of the display panel 130. During a response time τ1 of the liquid crystal capacitor CLC, the PWM signal 141a controls the light-emitting element 142 not to emit light. After the response time τ1 of the liquid crystal capacitor CLC is over, the PWM signal 141a controls the light-emitting element 142 to emit the light 143. Similarly, during a period of a second frame F2, a negative polarity pixel voltage of the second frame F2 is simultaneously updated to liquid crystal capacitors CLC (pixel elements) of all pixel circuits of the display panel 130. During a response time τ2 of the liquid crystal capacitor CLC, the PWM signal 141a controls the light-emitting element 142 not to emit light. After the response time τ2 of the liquid crystal capacitor CLC is over, the PWM signal 141a controls the light-emitting element 142 to emit the light 143. Therefore, the display panel 130 having fast response may also reduce/improve motion blur.

The blocks of the control circuit 110, the driving circuit 120, the light source circuit 140, and/or the dimming circuit 141 may be implemented by logical circuits (hardware) formed on an integrated circuit, and may also be implemented by using a central processing unit (CPU) through software. In different application scenarios, relevant functions of the control circuit 110, the driving circuit 120, the light source circuit 140, and/or the dimming circuit 141 may be implemented as software, firmware, or hardware by using general programming languages (e.g., C and C++), hardware description languages (e.g., Verilog HDL and VHDL), or other suitable programming languages. Regarding hardware implementation, one or more controllers, micro-controllers, micro-processors, application-specific integrated circuits (ASIC), digital signal processors (DSP), field programmable gate arrays (FPGA), and/or various other logical blocks, modules, and circuits in the processing unit may be used to implement or execute the functions described in the embodiments herein. Moreover, the device and method of the embodiments of the invention may be implemented through combinations of hardware, firmware, and/or software.

In summary of the above, the display device 100 and the operation method thereof described in the embodiments of the invention use the color filter display panel 130 having a function of analog frame buffer and can thus satisfy an application requirement for a high frame rate. Moreover, the dimming circuit 141 described in the embodiments of the invention controls/drives the light-emitting element 142 according to the duty ratio related to the response time of the liquid crystal capacitor CLC (pixel element) and can thus reduce/improve motion blur.

Although the invention is disclosed as the embodiments above, the embodiments are not meant to limit the invention. Any person skilled in the art may make slight modifications and variations without departing from the spirit and scope of the invention. Therefore, the protection scope of the invention shall be defined by the claims attached below.

What is claimed is:

1. A display device comprising:
a display panel comprising a color filter layer and a plurality of pixel circuits, wherein the pixel circuits respectively comprise a first preload switch, a second preload switch, a first storage capacitor, a second storage capacitor, a first driving switch, a second driving switch, and a pixel element, wherein a first terminal of the first preload switch and a first terminal of the second preload switch are coupled to a data line of the display panel, a first terminal of the first storage capacitor is coupled to a second terminal of the first preload switch and a first terminal of the first driving switch, a first terminal of the second storage capacitor is coupled to a second terminal of the second preload switch and a first terminal of the second driving switch, and a second terminal of the first driving switch and a second terminal of the second driving switch are coupled to the pixel element; and
a light source circuit comprising a dimming circuit and at least one light-emitting element, wherein the dimming circuit drives the at least one light-emitting element to generate a light according to a duty ratio related to a response time of the pixel elements of the pixel circuits, wherein the light passes through the color filter layer and the pixel elements of the pixel circuits to display an image.

2. The display device according to claim 1, wherein the pixel element comprises a liquid crystal capacitor.

3. The display device according to claim 1, wherein the duty ratio D≤1−τ/Tf, wherein τ is the response time, and Tf is a frame time.

4. The display device according to claim 1, wherein
during a first frame period, the first preload switch and the second driving switch are turned off, the first storage capacitor provides a pixel voltage of a first frame to the pixel element via the first driving switch, and the second storage capacitor receives a pixel voltage of a second frame from the data line via the second preload switch; and
during a second frame period, the second preload switch and the first driving switch are turned off, the second storage capacitor provides the pixel voltage of the second frame to the pixel element via the second driving switch, and the first storage capacitor receives a pixel voltage of a third frame from the data line via the first preload switch.

5. A method of operating a display device, comprising:
providing a display panel comprising a color filter layer and a plurality of pixel circuits, wherein the pixel circuits respectively comprise a first preload switch, a second preload switch, a first storage capacitor, a second storage capacitor, a first driving switch, a second driving switch, and a pixel element, wherein a first terminal of the first preload switch and a first terminal of the second preload switch are coupled to a data line of the display panel, a first terminal of the first storage capacitor is coupled to a second terminal of the first preload switch and a first terminal of the first driving switch, a first terminal of the second storage capacitor is coupled to a second terminal of the second preload switch and a first terminal of the second driving switch, and a second terminal of the first driving switch and a second terminal of the second driving switch are coupled to the pixel element; and
driving, by a dimming circuit, at least one light-emitting element to generate a light according to a duty ratio related to a response time of the pixel elements of the pixel circuits, wherein the light passes through the color filter layer and the pixel elements of the pixel circuits to display an image.

6. The method of operating the display device according to claim 5, wherein the pixel element comprises a liquid crystal capacitor.

7. The method of operating the display device according to claim 5, wherein the duty ratio D≤1−τ/Tf, wherein τ is the response time, and Tf is a frame time.

8. The method of operating the display device according to claim 5, further comprising:
during a first frame period, turning off the first preload switch and the second driving switch, providing a pixel voltage of a first frame to the pixel element via the first driving switch by the first storage capacitor, and receiving a pixel voltage of a second frame from the data line via the second preload switch by the second storage capacitor; and
during a second frame period, turning off the second preload switch and the first driving switch, providing the pixel voltage of the second frame to the pixel element via the second driving switch by the second storage capacitor, and receiving a pixel voltage of a third frame from the data line via the first preload switch by the first storage capacitor.
